(19) United States
(12) Patent Application Publication
(10) Pub. No.: US 2026/0153286 A1
(43) Pub. Date: Jun. 4, 2026

(54) METHOD FOR DRYING PANELS AND DRYER

(71) Applicant: GRENZEBACH BSH GmbH, Bad Hersfeld (DE)

(72) Inventor: Christoph STRAETMANS, Schenklengsfeld (DE)

(73) Assignee: GRENZEBACH BSH GmbH, Bad Hersfeld (DE)

(21) Appl. No.: 19/126,908

(22) PCT Filed: Nov. 2, 2023
(86) PCT No.: PCT/EP2023/025456

§ 371 Date: May 2, 2025

(30) Foreign Application Priority Data
Nov. 2, 2022 (DE) 10 2022 004 102.2

(51) Int. Cl. F26B 3/04; F26B 15/12; F26B 23/00; F26B 25/00

(52) U.S. Cl. CPC F26B 3/04; F26B 15/122; F26B 23/002; F26B 25/008

(57) ABSTRACT

A method for drying panels in a drying device including a first stage and a second stage, wherein the two stages each have levels and the panels are in each case laid on surfaces formed level-by-level and, in the respective levels of the two stages, are guided through the drying device, wherein the panels in the first stage are brought into contact with drying air of a high temperature and are dried, and in the second stage are dried with drying air of a less high temperature, is characterized in that at least in one of the two stages warm air is supplied to the panels from a means for recovering heat, wherein the means is arranged outside the two stages and wherein the warm air is supplied directly to the at least one stage.

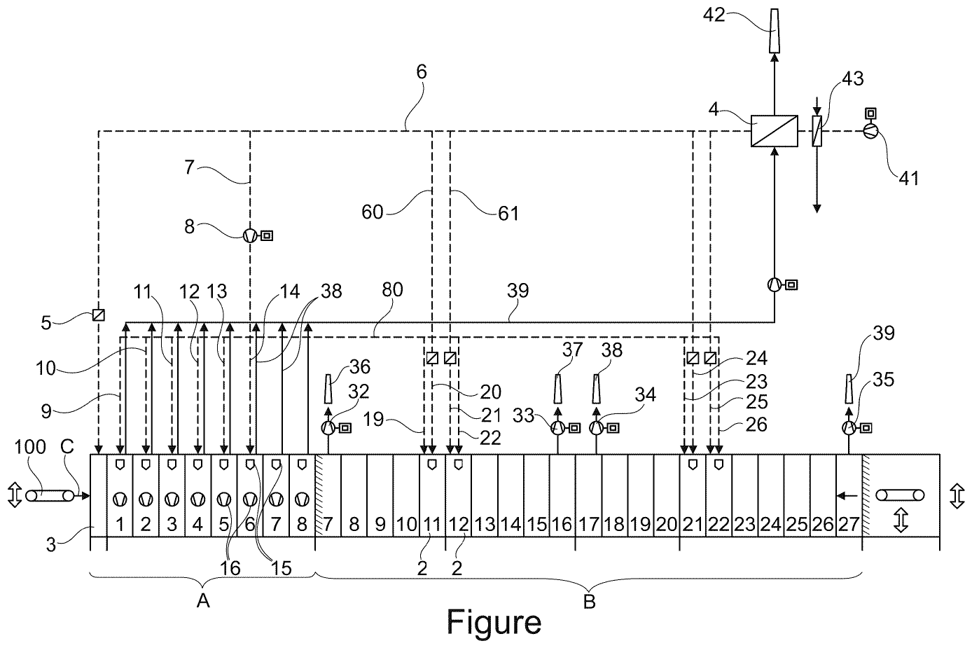

The present invention relates to a method for drying panels and to a dryer used for this purpose.

When drying panels, in particular cement and gypsum-containing building panels, the panels conveyed through a dryer are brought into contact with heated air.

The drying air can be supplied in the form of longitudinal ventilation, cross ventilation, or cross ventilation using nozzle boxes equipped with nozzles. In longitudinal ventilation, the drying air is supplied at one end of the dryer or, if it is divided into several zones, at one end of a zone and discharged at the opposite end.

In cross ventilation, it is supplied at several points on the sides of the dryer and discharged on the opposite sides, enabling more intensive drying in the dryer. Particularly intensive drying is achieved with cross ventilation via nozzles through the nozzle dryers in a turbulent flow.

In most cases, a recirculation process is used, in which a large proportion of the drying air is recirculated. In this case, most of the drying air is reheated after contact with the material to be dried and thus reused. Only a small proportion of the drying air is discharged to the outside as exhaust air, and a corresponding amount of fresh air is supplied from outside.

To heat the drying air, for example by means of burners or heating coils, fuel, i.e. primary energy, is required, and to supply the air by means of fans, electrical energy, i.e. secondary energy, is required. The use of both primary and secondary energy must be reduced in order to enable the above-mentioned plates to be manufactured in a more energy-efficient manner.

DE 26 13 512 A1 describes a drying process in which low primary energy consumption is achieved by using the condensation heat of the exhaust air. This process is designed in two stages. In the first drying stage, drying takes place at high temperature and high humidity, and in the second drying stage at low temperature and low humidity, with the drying capacity of the first stage being two to three times that of the second stage and the second drying stage being heated by the exhaust air from the first drying stage via a heat exchanger. In both stages, the drying air is supplied in a recirculation process, in the first drying stage in the form of longitudinal ventilation and in the second drying stage in the form of cross ventilation with a large recirculation mass flow. However, the second stage requires a large recirculation mass flow and thus a high consumption of secondary energy.

When reducing primary energy consumption by also using the condensation heat of the exhaust air, the general problem arises that the waste heat of the exhaust air is only available at a low temperature level. A lower temperature of the drying air can be compensated for by larger air mass flows; however, this leads to higher secondary energy consumption.

WO 95/04908 A1 discloses a method for drying plates conveyed through a dryer in layers, in which the plates are brought into contact with drying air in two stages A and B, with drying in stage A taking place in a recirculating air process with high-temperature drying air and at least medium air humidity and with a drying capacity two to four times higher than in stage B. In stage B, the exhaust air from stage A is passed through a heat exchanger arranged in the layers of the dryer; at the same time, the drying air with low temperature and low humidity is fed in counterflow to the exhaust air from stage A.

According to WO 2019/105888A1, at least two means for recovering heat are used, wherein the two means are arranged in series and wherein the heat from the first means is passed through a burner for further heating and only then is it introduced into the first stage of the dryer.

It is the object of the present invention to further improve the method according to the preamble of claim 1.

According to the invention, this object is resolved as specified in claim 1.

According to the invention, warm air is supplied to the panels in at least one of the two stages (A, B) by a means for recovering heat, wherein the means is arranged outside the two stages and wherein the warm air is supplied directly to the at least one stage.

This optimizes both the use of primary energy and secondary energy. In particular, the primary energy used is maintained by utilizing the waste heat and also the condensation heat of the exhaust air without increasing the secondary energy requirement by circulating large air masses.

Advantageous further developments of this method result from the subclaims and the description, in particular in conjunction with the drawings.

Preferably, the panels are heated at least in the first stage by warm air generated by a heat exchanger, by means of a heat pump, by means of a wet separator, by a burner directly or by means of hot steam or by means of thermal oil or electrically indirectly or by means of low-calorific heat.

According to the invention, the heat is at least supplied to the panels in the second stage, with at most a single means for recovering heat being provided.

Preferably, according to the method of the invention, the transport speed of the panels to be dried is also adapted to the respective energy absorption and the associated dehumidification of the panels, so that they are dried with minimal energy consumption.

The invention provides a method with low primary and secondary energy consumption. The primary energy used in the invention is kept low by utilizing the waste heat and the condensation heat of the exhaust air. Compared to the methods known from the prior art, this reduces the mass flow of the drying air and thus the consumption of secondary energy, because the recirculated air mass flows are reduced.

The invention makes particular use of waste heat from other processes taking place in the vicinity of the drying device, for example waste heat from a waste incineration plant or a combined heat and power plant; according to the invention, low-calorific heat available as waste heat from other exothermic processes can also be used.

Waste heat from a combined heat and power plant can also be used. This technology generates heat and electricity at the same time. Using a fuel to generate heat and electricity simultaneously in a single device is more efficient and cost-effective than generating heat and electricity separately in two different devices (COGEN technology or Combined-Heat-and-Power-Generation). Combined heat and power is up to 40% more efficient than generating heat and electricity separately. Combined heat and power is preferably operated with a renewable fuel. The electricity generated in this way can also be used in the system to transport the panels and operate fans.

The dryer system according to the invention is coupled with a solar and/or photovoltaic system in one embodiment. Alternatively, the dryer according to the invention uses heat from a geothermal system.

Usually, the front stage A and the rear stage B have the same number of floors arranged one above the other for guiding and conveying the panels. Usually, the floors also have the same height and the same distances from each other, so that the panels can be transferred from stage A to stage B without interruption. This applies in particular if the panels are conveyed at the same conveying speed in both stages. However, this does not exclude the possibility of selecting different conveying speeds in the two stages.

According to one embodiment of the invention, it is therefore possible to use different transport speeds for the panels to be dried in the two stages. The choice of speed for each stage, determined according to the desired drying progress, also results in a higher transport speed in stage A than in stage B for drying at a higher temperature in stage A than in stage B. This means that the speed of the panels leaving stage A is reduced to the speed level of stage B in a separate conveyor arranged between stage A and stage B. At the same time, in order to avoid intermediate storage of panels in the area of the conveyor, the conveyor distributes the panels over a larger area in stage B in accordance with the speed difference between stages A and B. This is done by dividing the panels over a larger number of levels or lanes in the area of stage B than in stage A. A conveyor device, for example a discontinuous conveyor, is used for this purpose, which on the one hand picks up panels at a higher speed on the side facing stage A and delivers them on the side facing stage B to a larger number of stages or tracks of stage B, the conveyor preferably having a lower speed on this side. The conveyor has a tipping point at the transition to stage B in order to distribute the panels to the levels of stage B. In the case of a higher number of tracks, several panels are preferably transported side by side on one level, for example in two to four tracks.

This measure creates a compact inlet area of the dryer with stage A, which can be traversed at high speed and high temperature and is also suitable for ensuring the final activation of solidifying agents such as starch contained in the panels. The strong heating in the front stage A combined with high humidity promotes the swelling of the solidifying agents contained in the building panels to be dried. In this way, high-quality panels can be produced.

If two stages with different conveyor speeds for the panels are implemented, the area and speed within stage B can be adjusted to achieve sufficient drying of the panels while making the best possible use of the energy from stage A.

In order to achieve rapid drying in stage A, the panels are preferably heated there by a cross-flow of hot air without the use of nozzle boxes. This allows the panels to be heated easily without the need for the structural effort involved in installing nozzle boxes. The panels are preferably heated in the front part of the dryer in a recirculating air process. Due to the high air humidity of the panels, the dew point is preferably between 60 and 99° C., most preferably between 75 and 90° C.

The heat supplied to the panels in stage A is preferably generated at least in part by a means for recovering heat, in particular by a heat pump. At least some of the zones of stage A are additionally equipped with heaters, in particular the front zones of stage A. Alternatively, stage A can also be heated completely with the heaters installed in it.

The comprehensive heating of the first stage generates high air humidity in this stage, which means that the dew point rises to a temperature of 75° C. to 99° C., with the dew point preferably lying between 75° C. and 90° C. The air humidity is between 200 and 600 g per kilogram of air.

To simplify the design of stage A, it is also possible to place the zones of stage A directly on the floor of an industrial building without a separate floor for the dryer. This allows stage A to be implemented in a lightweight construction; if stage A consists of a large number of modules arranged one behind the other in the direction of production, these modules can be easily installed and removed, for example to repair or replace the fans installed in the zones, particularly in the ceiling areas.

Although the nozzle boxes enable the panels to be dried well in a short period of time, they require a high energy input to generate the necessary air flow. On the other hand, the nozzle boxes also take up a considerable amount of space within stage A, which usually has a plurality of sections, and the nozzle boxes are arranged one above the other in each of the sections according to the number of floors in stage A.

According to the invention, a longitudinal ventilation design of stage A is just as possible as the use of nozzle boxes.

Both stages are divided into fields or sections. In both stages A and B, for example, a drying device is provided with a conveyor system with a plurality of fields or sections extending one behind the other in the conveying direction for conveying panels to be dried, which pass through in a plurality of tiers per field, with conveying devices arranged in the tiers and designed as roller conveyors. Preferably, a separate conveyor chain is provided for the panels in each field; however, the panels can also be driven in a plurality of fields by a conveyor chain common to these fields, whereby a conveyor chain drives the panels over five fields, for example.

Stage B requires a larger drying area due to the longer drying time of the panels to be dried; it is therefore longer than stage A.

In both stages A and B of the dryer, a drive system is used which is adapted to a dryer operating at low temperatures and to the large number of panels, in particular gypsum plasterboards, which are simultaneously processed in the low-temperature dryer over a large number of floors, for example sixteen to sixty floors, in particular twenty to fifty floors, and particularly preferably thirty to forty floors. are processed simultaneously. By using a large number of floors in conjunction with the drive system according to the invention, it is possible to achieve a longer dwell time for the panels, in particular the gypsum plasterboard panels, in a low-temperature dryer with the same dryer length as in a high-temperature dryer, while maintaining the same panel output as in a high-temperature dryer.

It can thus be seen that the installation of the dryer arrangements according to the invention in an existing plant enables particularly large energy savings.

For optimized utilization of the waste heat generated in stage A in particular, the panels are dried in the first stage A and/or in the second stage B by at least one external heat exchanger and/or alternatively by internal heat exchangers.

It is also advantageous if the panels in the first stage A are heated directly by means of recirculated air through a burner or indirectly by means of hot steam or thermal oil or electrically or by means of low-calorific heat. In stage B, panels are heated by low-calorific heat, which either comes from heat recovery from stage A or from another process in which heat is released at low temperatures, for example from a combined heat and power plant or a heat pump.

Preferably, the panels in the first stage A are dried with drying air at a temperature in the range between 90 and 160° C., in particular between 120 and 140°. The choice of low temperatures allows the panels to be dried gently. No gypsum anhydrite is formed in the panels.

When the panels are dried in the first stage A in these temperature ranges, the warm air absorbs a great deal of moisture, and the temperature and circulation speed of the air are preferably selected so that the dew point of the warm air is between 60 and 99° C.

The drying zones of the first stage A either have cross ventilation or, alternatively or additionally, longitudinal ventilation. If high temperatures are to be reached, stage A is preferably heated at least partially indirectly via a heat pump, for example to 50%. Alternatively, the zones of stage A are heated by burners or indirectly.

In the second stage B, the panels are dried with drying air at a temperature of 20 to 90° C., preferably between 30 and 90° C.

The exhaust air from the drying process of the first stage A can be advantageously reused by passing it into a heat exchanger to preheat the drying air of the second stage B.

An even higher efficiency of the drying process according to the invention can be achieved if the panels are first dried in a pre-drying stage upstream of the first stage A, then in the first stage A and finally in the second stage B.

Preferably, the panels are conveyed through the stages A and B by means of conveyor devices separate for each stage A, B and/or for each section. Alternatively, the conveyor devices are driven by direct drive motors or are at least partially connected to each other by means of gearboxes.

The invention also provides a dryer for drying panels in a first and a second stage A, B, each of which is equipped with a conveyor device for conveying the panels arranged in layers through the dryer, wherein the first stage (A) has at least one zone, wherein the first stage A has a feed device, a discharge device and a recirculation duct with conveying means and a heating device for recirculating air, as well as means for supplying supply air and means for discharging exhaust air, and wherein the second stage B is equipped for receiving the panels from the first stage A and with a supply device for drying air and a discharge device for drying air; Alternatively, a heating device may also be provided in the second stage.

In particular, high conveying capacities for circulating the air are avoided in the second stage, so that this dryer has only low secondary energy consumption.

Preferably, the housing of the dryer is equipped with a door for each dryer stage A, B. Preferably, the dryer, especially in stage B, does not have its own floor, but is built on the screed of a factory hall.

An advantage is a dryer in which the first and second stages A, B each comprise at least one section or zone, equipped with means for flowing the recirculated air transversely to the conveying direction of the panels, especially in the first stage A.

For design reasons, the first stage A of the dryer is preferably divided into several sections, which are at least partially equipped with devices for cross ventilation; in particular, fans are provided in the front zones of stage A, especially in the ceiling areas; however, the fans can also be mounted on the outside, especially above the upper covers of the zones, if the recirculated air generated by them is then directed into the interior of the zones. Air guide elements are preferably provided within the zones for this purpose. For example, cross ventilation is achieved by means of hot air impinging on a surface.

Preferably, only longitudinal ventilation is provided in stage B, i.e., in the rear stage, which does not exclude the provision of additional and/or exclusive means for cross ventilation in stage B. In stage B, the panels have a temperature between 30° C. and 90° C.; during the drying of the panels in stage B, the air humidity there is between 5 and 30 g/kg, i.e., per kilogram of air.

It is advantageous to provide the second stage B of the dryer with means for flowing the recirculating air against and/or in the direction of conveyance of the panels.

In a further advantageous embodiment of the dryer, the second stage B is provided with guide means for guiding the recirculating air in a helical manner or with at least one exhaust fan. Auxiliary guide means, for example in the form of guide panels, are provided.

Roller conveyors or conveyor belts are preferably provided as conveying devices for transporting the panels to be dried in the dryer.

By also using the condensation heat made possible by the low temperature of the drying air cooling the heat exchanger and the at least moderate humidity of the exhaust air from stage A, the primary energy is used intensively.

When the drying air is guided in counterflow to the exhaust air from stage A passing through the heat exchanger, cooler drying air meets already cooled exhaust air. This ensures that the water vapor contained in the exhaust air is condensed as far as possible and further improves the utilization of the primary energy. The more intensive use of primary energy leads to considerable savings in primary energy.

Overall, stage B dries with a maximum of 60% of the drying capacity of stage A.

Each stage A and B is equipped with a conveyor device for conveying panels arranged in layers through the dryer. The dryer can be designed as a roller conveyor dryer or a belt dryer, whereby the conveyor device has several roller conveyors or conveyor belts arranged one above the other.

The shelves are spaced apart by a distance of between 100 mm and 150 mm, preferably 130 mm.

Additional heating devices can be installed in stage B for additional transient loads.

The invention is explained in more detail below with reference to an embodiment.

The single FIGURE shows a dryer with two stages A and B and a heat pump.

A dryer 1 (FIGURE) comprises two stages A and B for drying panels which are fed to the dryer 1 via a conveyor device 100 such as a conveyor belt in the direction of an arrow C. These panels are in particular building material panels, for example plasterboard panels or gypsum wall panels.

Each of the two stages A and B is preferably divided into sections or zones 2. At least some zones 2, in particular the front zones 2, of stage A are each equipped with recirculation fans 15 for generating a flow transverse to the conveying direction of the panels.

Preferably, stage A has a sealing section 3 on the inlet side. The sealing section 3 is supplied with fresh air heated by a heat pump 4 or a heat exchanger 4 via a supply line 6 equipped with a closable flap 5; this fresh air supply serves not only to heat the panels but also to seal stage A against other air flows and the ingress of outside air into stage A.

Via a pipe 7 branching off from the supply pipe 6, fresh air heated by a fan 8 is distributed via a further pipe 80 to individual pipes 9, 10, 11, 12, 13, 14. From there, the fresh air reaches heating devices 15 installed in some of the zones 2, which are arranged, for example, in a ceiling box above the floors on which the panels are conveyed. The heating devices 15 are preferably direct heating devices such as burners or indirect heating devices such as steam or electric heaters. Within the zones 2 or jointly for several zones 2, at least one recirculation fan 16 is provided to generate a cross-flow of the heated air in the zones 2 as recirculated air. Alternatively, two recirculation fans 16 are arranged for each zone 2. The air enriched with moisture is returned from the zones 2 to the heat exchanger 4 via outlets 38, where the moisture condenses out of it.

From stage A, the pre-dried panels are transported to stage B, which is designed as a longitudinal dryer.

Stage B is also supplied with heated fresh air from the heat exchanger 4. Pipes 19 to 26 are used for this purpose.

Fans can also be installed in pipes 19 to 26. At the inlet of sections 2 of stage B, the air flowing into sections 2 from pipes 19 to 26 is heated by heating devices 29 to 31.

The heating devices 29 to 31 are switched on when additional heating energy is required; this is the case when the system is started up, when insufficient heat is still being supplied from stage A and the heat exchanger 4 is not yet receiving any warm exhaust air or not enough warm exhaust air from stage A. The heating devices are also required when the system is shut down and insufficient warm air is supplied from stage A for entry into stage B. The heating devices 29 to 31 can also be used if the panels to be dried have a higher moisture content than expected, or when changing between different panel formats, which can lead to a lack of heat energy in stage B. The heating devices 29 to 31 are therefore provided in particular for transient loads in stage B.

It is understood that, depending on the length of stage B, a large number of lines for supplying air, in particular warm air from the heat exchanger 4 or from another heat exchanger, may be provided in order to recover the evaporation enthalpy of the water evaporated from the panels.

As a rule, recirculation fans are not required in stage B; however, if such recirculation fans must be provided, they are constructed and arranged in the same way as the recirculation fans in stage A. Both radial and axial fans can be used.

Just like the recirculation fans, exhaust fans 32 to 35 are distributed over the entire length of stage B. Moist air is extracted from stage B via these and chimneys 36 to 39.

Additional internal heat exchangers can be provided in both stage A and stage B, for example above the nozzle boxes in stage A in a ceiling box or above the conveyor in stage B, also in a ceiling box provided for this purpose.

The heat exchanger 4 is connected to zones 2 of stage A via exhaust air ducts 38 and a central exhaust air duct 39. Warm, moisture-saturated air is conducted via the exhaust air ducts 38, 39 to the heat exchanger 4 via an exhaust air fan 40, where it condenses and releases its moisture as water.

The heat exchanger 4 draws in fresh air via a fresh air fan 41. It discharges stale air to the environment via a chimney 42. A condensate separator 43 is provided between the fresh air fan 41 and the heat exchanger 4.

Stage B is designed as a longitudinal drying area; depending on the strength of the air supply via lines 19 to 26 in relation to the extraction of the used air by fans 32 to 34, the air is directed in counterflow to the direction of conveyance of the panels, at least in the front area of stage B.

Since temperatures of 160° C. are preferably not exceeded in the dryer as a whole, building boards of all kinds, in particular gypsum boards, but also cement boards, are dried very gently and with low energy consumption in the dryer according to the invention, whereby high-quality boards can be produced.

The large number of floors, which are relatively low in height, also enables the panels to be dried very efficiently, as a large number of panels can be dried simultaneously in a small space. If the panels are also conveyed in several lanes next to each other, production efficiency is further increased.

1. A method for drying panels in a drying device comprising a first stage and a second stage, wherein the two stages each have tiers and the panels are placed on surfaces formed in tiers and are passed through the drying device in the respective tiers of the two stages through the drying device, wherein the panels are brought into contact with high-temperature drying air and dried in the first stage and are dried with drying air at a lower temperature in the second stage, wherein the panels are supplied with warm air from a means for recovering heat in at least one of the two stages with warm air from a means for recovering heat, wherein the means is arranged outside the two stages and wherein the warm air is supplied directly to the at least one stage.

2. The method according to claim 1, wherein the panels are heated at least in the first stage by warm air generated by a heat exchanger, by means of a heat pump, by means of a wet separator, by a burner directly or by means of hot steam or by means of thermal oil or electrically indirectly or by means of low-calorific heat.

3. The method according to claim 1, wherein the moisture contained in the air condenses in the first stage at a dew point between 60° C. and 99° C.

4. The method according to claim 3, wherein the moisture contained in the air condenses in the first stage at a dew point between 75° C. and 90° C.

5. The method according to claim 1, wherein the moisture contained in the air in the second stage is between 5 g/kg and 30 g/kg per kilogram of air.

6. The method according to claim 1, wherein the panels are dried by circulating air at least in the first stage.

7. The method according to claim 1, wherein the panels are dried at least in the first stage by drying air at a temperature of 120° C. to 160° C.

8. The method according to claim 1, wherein the panels are dried at least in the region of the first stage at least substantially by the use of nozzle boxes.

9. The method according to claim 1, wherein the panels are dried in the second stage by drying air at a temperature of 20 to 90° C.

10. The method according to claim 1, wherein the exhaust air from the first stage is fed into a heat exchanger for preheating the drying air of the second stage.

11. The method according to claim 1, wherein the panels are first dried in a sealing stage or pre-drying stage upstream of the first stage, then in the first stage and finally in the second stage.

12. A dryer for drying panels in a first stage and a second stage, wherein at least one of the two stages can be supplied with warm air from a means for recovering heat, wherein the means is arranged outside the two stages and wherein the warm air can be supplied directly to the at least one stage.

13. The dryer according to claim 12, wherein the means for recovering heat comprises a heat exchanger, a heat pump, a wet separator, and/or a burner for direct or indirect heating of the warm air by means of hot steam or by means of thermal oil or by indirect electric heating or by means of low-calorific heat, wherein at most a single means for recovering heat is provided.

14. The dryer according to claim 12, wherein the panels in the first stage can be heated by warm air flowing transversely to the direction of conveyance and in the second stage by warm air flowing in the longitudinal direction.

15. The dryer according to claim 12, wherein the second stage is equipped with means for flowing the recirculated air counter to and/or in the direction of conveyance of the panels.

16. The dryer according to claim 12, wherein a condensate separator is arranged upstream of the at least one heat exchanger.

17. The dryer according to claim 12, wherein it has at least sixteen floors in which the panels are dried and transported.

18. The dryer according to claim 12, wherein the floors are spaced 150 mm or less apart.
